(19) United States
(12) Patent Application Publication
(10) Pub. No.: US 2007/0138324 A1
(43) Pub. Date: Jun. 21, 2007

(54) Armature assembly with improved alignment capability

(76) Inventors: Daniel Richard Ibrahim, Metamora, IL (US); Neal A. Lelfheit, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/311,300

(22) Filed: Dec. 20, 2005

(51) Int. Cl. F02M 51/00; B05B 1/30

(52) U.S. Cl. 239/585.4

(57) ABSTRACT

A solenoid actuator for a fuel injector may include a force transfer element defining a longitudinal axis, an armature operatively coupled to the force transfer element, and a stator configured to selectively move the armature substantially along the axis. The solenoid actuator may also include a fastening assembly to operatively connect the armature and the force transfer element, the fastening assembly being configured to allow the armature to pivot in at least one dimension relative to the axis.

### TECHNICAL FIELD

The present disclosure relates to an armature assembly, and, more particularly, to an armature assembly having an aligned armature and stator.

### BACKGROUND

Solenoid actuators, such as those used in valves for fuel injectors, can include two major components, commonly referred to as the stator and the armature. The stator is a magnetic device, for example an electromagnet, that causes the armature to move through magnetic attraction. The armature may be attached to a force transfer element to provide electromechanical operation of a valve between two or more positions. In a fuel injector, for example, the solenoid actuator may control the flow of fuel through the valve.

In most solenoid actuator applications, it is desirable for nominal force levels, response times, and other performance related characteristics to be consistent from one solenoid actuator to the next. This consistency may be achieved by minimizing the error in parallelism between the stator and the armature. Out of parallel conditions can cause the armature to contact the stator. This contact can interfere with valve operation and potentially damage these components. To avoid contact between the armature and the stator, engineers can increase the air gap between the two components to avoid contact even at a worst-case parallelism condition. This increased air gap, however, can reduce the nominal force levels and flexibility of the actuator design.

Additionally, an out of parallel condition tends to increase the mean force available at a particular mean air gap, which impacts the performance of the actuator. Therefore, assembly of solenoid actuators with consistent parallelism is desirable in order to maintain minimal variation among similarly assembled solenoid actuators.

At least one system has been developed for minimizing contact and maintaining a consistent air gap between the armature and the stator. For example, U.S. Pat. No. 6,648,248 (the U.S. Pat. No. '248 patent), issued to Adachi et al. on Nov. 18, 2003, describes a system for reducing undesirable loads on the stator and minimizing or preventing contact between the stator and the armature. Particularly, the system of the U.S. Pat. No. '248 patent includes an armature with an annular protrusion configured to engage a stopper. When the stator is energized and the armature moves, the stopper is not joined directly to the stator, which can reduce undesirable loads on the stator.

While the system of the U.S. Pat. No. '248 patent may be effective for reducing undesirable loads on the stator and minimizing contact between the stator and armature, the system of the U.S. Pat. No. '248 patent includes several disadvantages. For example, the system does not address an out of parallel condition and, therefore, part-to-part performance variation may exist.

Other existing armature designs may rely on holding tight tolerances on component parts to maintain parallelism. These tight tolerances are expensive to manufacture and control in volume production. Typical capabilities of current manufacturing methods and designs are insufficient to provide the level of parallelism consistency required in the next generation of fuel injectors.

The present disclosure is directed to overcoming one or more of the problems or disadvantages existing in the prior art.

### SUMMARY OF THE INVENTION

One disclosed embodiment includes a solenoid actuator, which may include a force transfer element defining a longitudinal axis, an armature operatively coupled to the force transfer element, and a stator configured to selectively move the armature substantially along the axis. The valve may also include a fastening assembly to operatively connect the armature and the force transfer element, the fastening assembly being configured to allow the armature to pivot in at least one dimension relative to the axis.

Another disclosed embodiment includes a method of assembling a solenoid actuator valve. The method may include placing an armature on a force transfer element, pivoting the armature relative to the force transfer element to an adjusted armature position, and maintaining the armature in the adjusted armature position.

### BRIEF DESCRIPTION OF THE DRAWINGS

FIG. 1 provides a diagrammatic illustration of a work machine, according to an exemplary disclosed embodiment.

FIG. 2 provides a diagrammatic illustration of a solenoid actuator valve for a fuel injector of an engine, according to an exemplary disclosed embodiment.

FIG. 3 provides an assembly stage diagrammatic illustration of the solenoid actuator valve of FIG. 2.

FIG. 4 provides a diagrammatic illustration of a solenoid actuator valve for a fuel injector of an engine, according to another exemplary disclosed embodiment.

FIG. 5 provides an assembly stage diagrammatic illustration of the solenoid actuator valve of FIG. 4.

### DETAILED DESCRIPTION

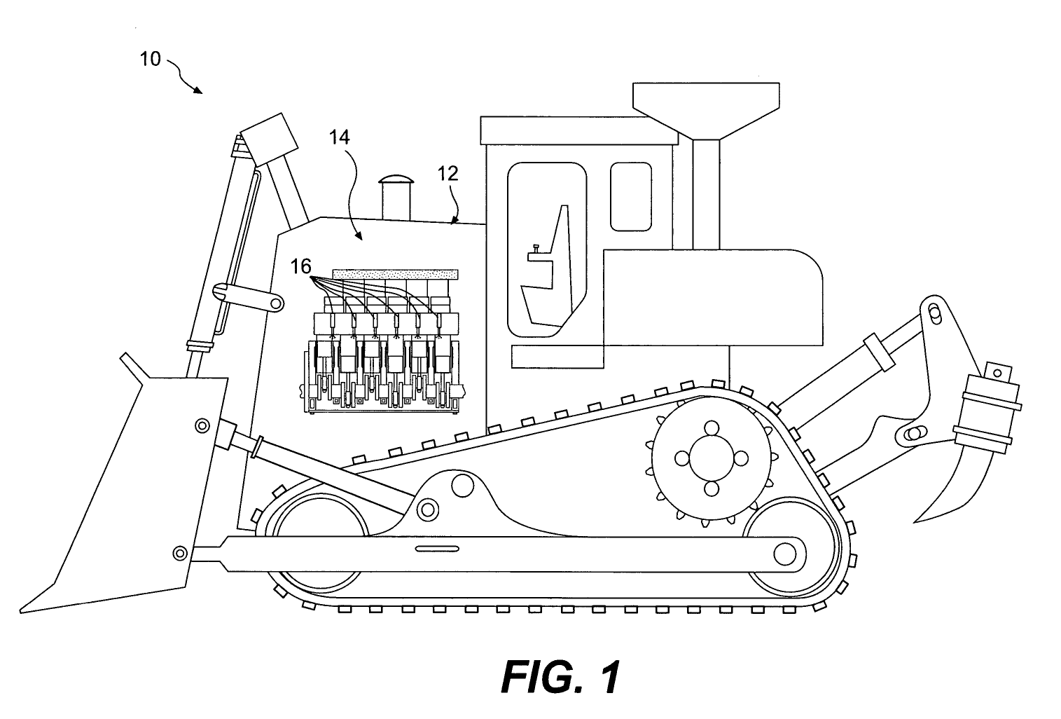

FIG. 1 provides a diagrammatic perspective view of a work machine 10 according to an exemplary disclosed embodiment. Work machine 10 may include a frame 12 and an engine 14. While work machine 10 is illustrated as being a bulldozer, work machine 10 may be any type of machinery that includes an engine that operates on fuel. For example, work machine 10 may be an on-highway vehicle, off-highway vehicle, wheel loader, excavator, skid steer, generator and other types of machinery.

Engine 14 may be provided with one or more fuel injectors 16, which provide fuel to one or more combustion chambers of engine 14 at a controlled rate. While six fuel injectors 16 are illustrated in FIG. 1, engine 14 may include any number of fuel injectors 16, depending on the particular size and configuration of engine 14.

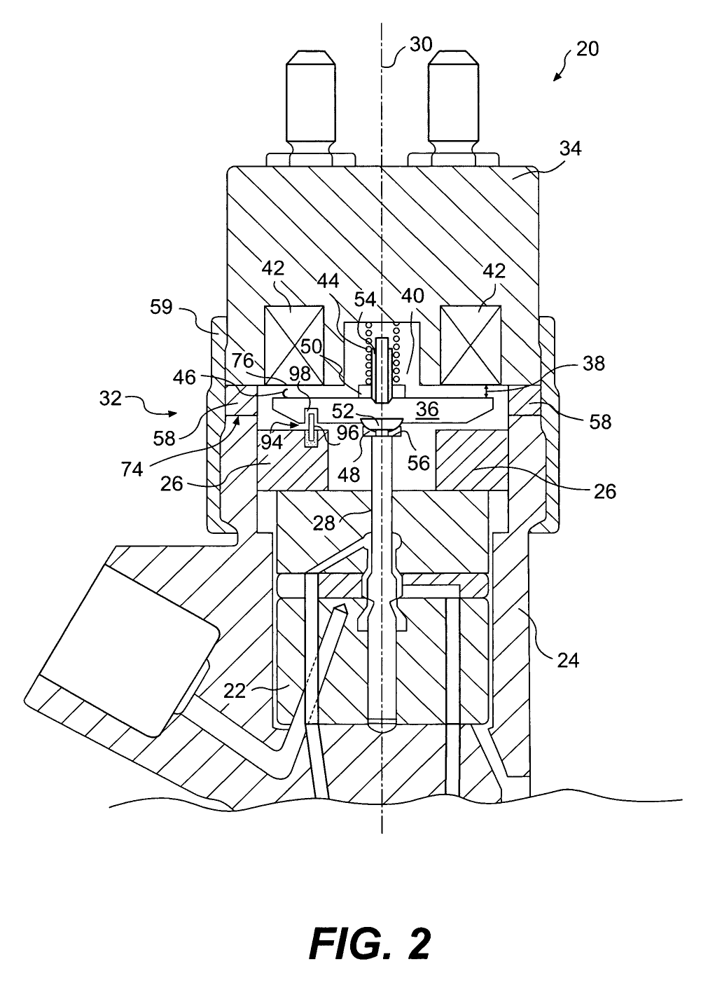

FIG. 2 provides a diagrammatic illustration of a valve 20 that may be included in fuel injector 16. Valve 20 may include a valve assembly 22, which may be secured to a fuel injector body 24 of fuel injector 16 by a valve screw 26. Although valve assembly 22 is shown as a poppet valve, other valve types, including spool valves, or combinations of various types of valves could be used. A force transfer element 28, defining a longitudinal axis 30, may protrude from valve assembly 22 and be secured to a solenoid actuator 32. Force transfer element 28 may operate between two or more positions to control fuel flow through valve assembly 22.

Solenoid actuator 32 for valve 20 may be configured to provide a force for moving force transfer element 28 between two or more positions. Solenoid actuator 32 may include two main components: a stator 34 and an armature 36 separated from one another by an air gap 38. Force transfer element 28 may pass through a hole (not shown) in armature 36 and may be fastened to armature 36 by a fastening assembly 40.

Stator 34 may include a pattern of stator coils 42 arranged above armature 36. As alternating current is passed through stator coils 42, a magnetic field may be formed. This magnetic field may be selectively turned on and off by controlling the flow of electrical current to stator 34. Armature 36 may be formed of any suitable material that may be influenced by a magnetic force. A spring 44 may be disposed between fastening assembly 40 and stator 34 to provide an opposing force on armature 36 when armature 36 is magnetically attracted by stator coils 42. In this manner, stator 34 can selectively actuate armature 36 substantially along axis 30 of force transfer element 28 over an approximate range of motion 46, as shown in FIG. 2. Range of motion 46 may be, for example, 0.035 millimeters to 0.060 millimeters, and a width of air gap 38 may be, for example, 0.075 millimeters, when armature 36 is up, and 0.110 millimeters, when armature 36 is down.

Fastening assembly 40 may include two washers 48 and 50, a half-spherical portion 52, and a retaining element 54. A first side of washer 48 may face a spherical side of half-spherical portion 52 to provide a surface on which half-spherical portion 52 may pivot. An opposite side of washer 48 may rest on a shoulder 56 of force transfer element 28. Armature 36 may be disposed between washer 50 and half-spherical portion 52, with armature 36 facing a non-spherical side of half-spherical portion 52.

Retaining element 54 of fastening assembly 40 may be configured to secure washer 50, armature 36, half-spherical portion 52, and washer 48 to force transfer element 28. Retaining element 54 may include a nut, for example, secured to a top portion of force transfer element 28. Retaining element 54 may apply a retaining pressure on washer 50, half-spherical portion 52, washer 48, and armature 36, with shoulder 56 of force transfer element 28 providing an opposing pressure. Retaining element 54 may attach to a top portion of force transfer element 28 by means of a threaded connection, for example. When solenoid actuator 32 is assembled, retaining element 54 may apply a retaining pressure on elements of fastening assembly 40, armature 36, and shoulder 56, to maintain armature 36 in an adjusted armature position relative to axis 30.

Shims 58, which may be available in varying thicknesses, may be provided between stator 34 and fuel injector body 24 to maintain air gap 38 between stator 34 and armature 36. Stator 34 and shims 58 may be secured to fuel injector body 24 by a fastening element 59.

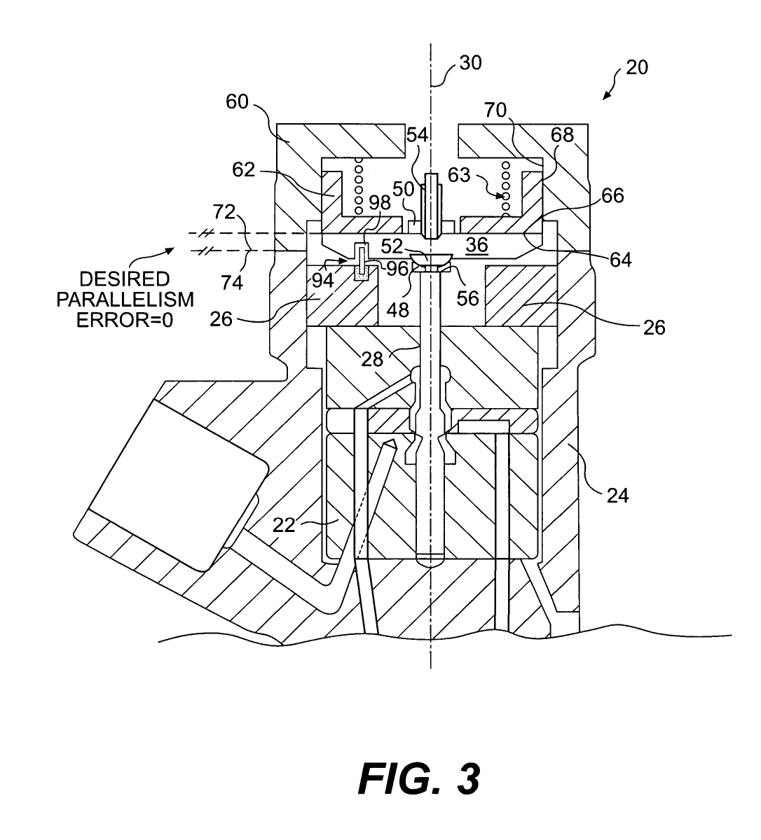

FIG. 3 provides a diagrammatic illustration of solenoid actuator 32 during an assembly stage, illustrating the process by which stator 34 is aligned with armature 36 to minimize parallelism error. Valve assembly 22, force transfer element 28, valve screw 26, fuel injector body 24, armature 36, fastening assembly 40 (including, for example, washers 48 and 50 and half-spherical portion 52), retaining element 54, and shoulder 56 of FIG. 3 each correspond to similarly labeled components of FIG. 2.

During the assembly stage, washer 48, half-spherical portion 52, armature 36, and washer 50 may be loosely assembled. An alignment guide 60, an alignment plunger 62, and a spring 63 may be provided to perform an assembly stage alignment of armature 36. Alignment plunger 62 may be placed over force transfer element 28, armature 36, and fastening assembly 40, so that a bottom surface 64 of alignment plunger 62 may be adjacent to a top surface 66 of armature 36. Spring 63 and alignment guide 60 may then be placed over alignment plunger 62 such that an outer wall 68 of alignment plunger 62 is adjacent to an inner wall 70 of alignment guide 60 and a bottom surface 72 of alignment guide 60 is adjacent to a shim surface 74. Without the presence of retaining element 54, fastening assembly 40 is configured to permit armature 36 to pivot in one or more dimensions relative to axis 30 of force transfer element 28. In this manner, alignment plunger 62 can aid alignment guide 60 to align top surface 66 of armature 36 so that it is substantially parallel to bottom surface 64 of alignment plunger 62. Furthermore, top surface 66 of armature 36 may be aligned to be substantially parallel to shim surface 74 due to the adjacency of outer wall 68 of alignment plunger 62 to inner wall 70 of alignment guide 60 and the adjacency of bottom surface 72 of alignment guide 60 to shim surface 74.

To maintain a substantially parallel relationship between top surface 66 of armature 36 and shim surface 74 during operation, a detaining means 94 may also be provided to prevent rotation of armature 36 about axis 30. Axis 30 of force transfer element 28 is shown as being perpendicular to shim surface 74 but may actually tilt slightly in one direction. Thus, any rotation of armature 36 about axis 30 will cause top surface 66 of armature 36 to vary from a consistent plane relative to shim surface 74. Detaining means 94 may prevent such rotation from occurring. Detaining means may include, for example, a dowel pin 96 secured to valve screw 26 and extending into a predrilled hold 98 in the bottom of armature 36. Predrilled hole 98 may be sufficiently deep to allow movement of armature 36 over its approximate range of motion 46. During operation, any torque acting on force transfer element 28 will be counteracted by dowel pin 96 pressing against a side of predrilled hole 98, thus preventing any rotation of armature 36.

After the top surface of armature 36 is adjusted to be in a substantially parallel relationship with shim surface 74, as shown in FIG. 3, retaining element 54 may be secured to maintain armature 36 in an adjusted armature position. After assembly stage, alignment plunger 62 and alignment guide 60 may be removed. Referring back to FIG. 2, stator 34 may be assembled in place of alignment plunger 62 and alignment guide 60, with a bottom surface 76 of stator 34 being adjacent with a top surface of shims 58. In this manner, the top surface of armature 36 can be maintained in a substantially parallel relationship with bottom surface 76 of stator 34.

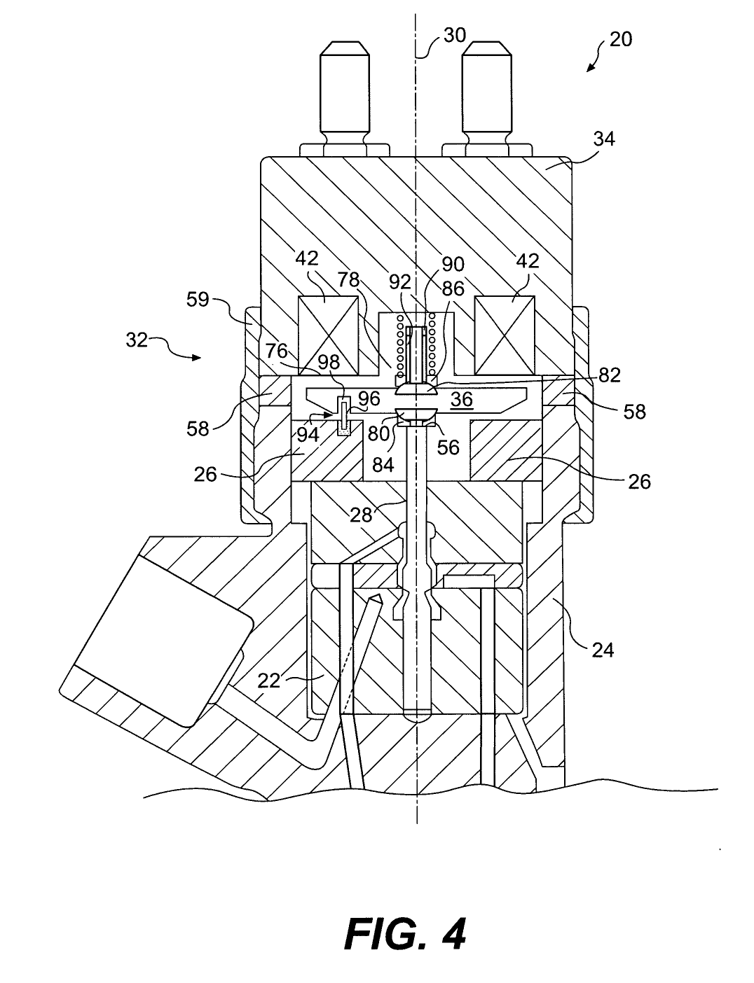

FIG. 4 provides a diagrammatic illustration of a second embodiment of a solenoid actuator 32 for fuel injector 16. In this embodiment, a fastening assembly 78 includes two half-spherical portions 80 and 82, two washers 84 and 86, a retaining element 90, and a tubular portion 92. One side of washer 84 may face a spherical side of half-spherical portion 80 to provide a surface on which half-spherical portion 80 may pivot. An opposite side of washer 84 may rest on shoulder 56 of force transfer element 28. Armature 36 may be disposed between half-spherical portion 82 and half-spherical portion 80, with armature 36 facing non-spherical sides of half-spherical portions 80 and 82. One side of washer 86 may face a spherical side of half-spherical portion 82. An opposite side of washer 86 may be adjacent to tubular portion 92.

Retaining element 90 of fastening assembly 78 may be configured to secure washer 86, half-spherical portion 82, armature 36, half-spherical portion 80, and washer 84 to force transfer element 28. Retaining element 90 may include a nut, for example, secured to a top portion of force transfer element 28. Tubular portion 92 may be disposed about force transfer element 28 to transfer a retaining pressure from retaining element 90 to washer 86. When solenoid actuator 32 is assembled, retaining element 90 may apply a retaining pressure on elements of fastening assembly 78, armature 36, and shoulder 56 to maintain armature 36 in an adjusted armature position relative to axis 30.

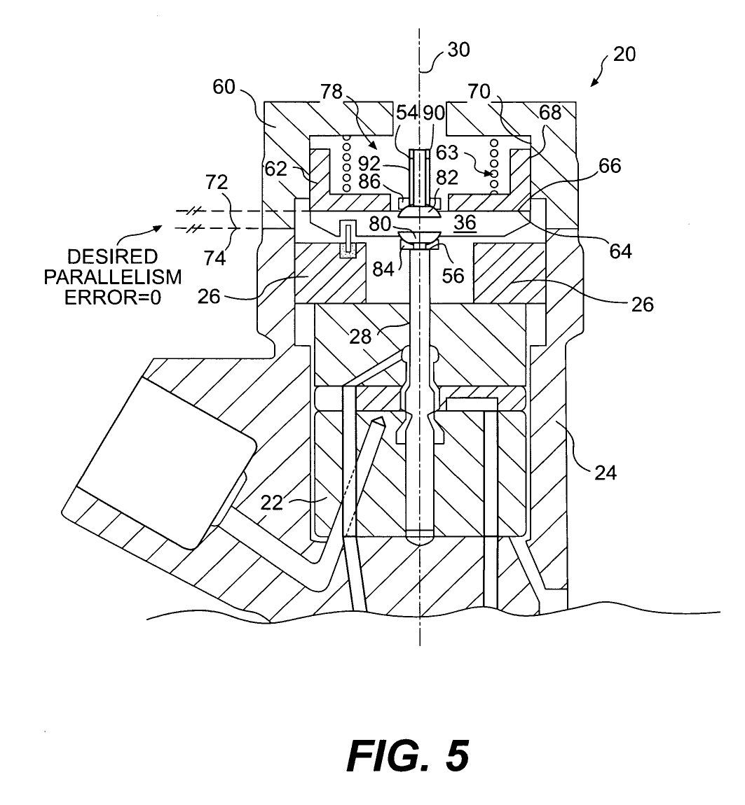

FIG. 5 provides a diagrammatic illustration of a second embodiment of solenoid actuator 32 during an assembly stage, illustrating the process by which stator 34 is aligned with armature 36 to minimize parallelism error. During the assembly stage, washer 84, half-spherical portions 80 and 82, armature 36, and washer 86 may be loosely assembled. Alignment guide 60, alignment plunger 62, and spring 63 may be provided to perform an assembly stage alignment of armature 36. Alignment plunger 62 may be placed over force transfer element 28, armature 36, and fastening assembly 78, so that bottom surface 64 of alignment plunger 62 may be adjacent to top surface 66 of armature 36. Spring 63 and alignment guide 60 may then be placed over alignment plunger 62 such that outer wall 68 of alignment plunger 62 is adjacent to inner wall 70 of alignment guide 60 and bottom surface 72 of alignment guide 60 is adjacent to shim surface 74. Without the presence of retaining element 90, fastening assembly 78 is configured to permit armature 36 to pivot in one or more dimensions relative to axis 30 of force transfer element 28. In this manner, alignment plunger 62 can aid alignment guide 60 to align top surface 66 of armature 36 so that it is substantially parallel to bottom surface 64 of alignment plunger 62. Furthermore, top surface 66 of armature 36 may be aligned to be substantially parallel to shim surface 74 due to the adjacency of outer wall 68 of alignment plunger 62 to inner wall 70 of alignment guide 60 and the adjacency of bottom surface 72 of alignment guide 60 to shim surface 74.

After the top surface of armature 36 is adjusted to be in a substantially parallel relationship with shim surface 74, as shown in FIG. 5, retaining element 90 and tubular portion 92 may be applied to maintain armature 36 in an adjusted armature position. After assembly, alignment plunger 62 and alignment guide 60 may be removed. Referring back to FIG. 4, stator 34 may be assembled in place of alignment plunger 62 and alignment guide 60, with bottom surface 76 of stator 34 being adjacent with the top surface of shims 58. In this manner, the top surface of armature 36 can be maintained in a substantially parallel relationship with the bottom surface 76 of stator 34.

### INDUSTRIAL APPLICABILITY

The disclosed solenoid actuator and assembly method may be used to correct face parallelism in any solenoid actuator application. In one exemplary disclosed embodiment, solenoid actuator 32 may be used to control valve assembly 22 in fuel injector 16 to provide a controlled flow of fuel to engine 14.

The presently disclosed solenoid actuator 32 has several advantages. The disclosed method of assembly provides consistently low parallelism error. Consistently low parallelism error results in consistent nominal force levels and consistent response times from one set of assembled solenoid actuators to the next.

Solenoid actuator 32 can also minimize or prevent contact between armature 36 and stator 34. Since contact between armature 36 and stator 34 may result in interference with operation of valve assembly 22, the disclosed solenoid actuator 32 may avoid such interference. Furthermore, solenoid actuator 32 can reduce or eliminate design concerns with worst-case parallelism. Without the concern of worst-case parallelism, solenoid actuators may be designed with smaller air gaps, which may further increase the nominal force levels of the solenoid actuator design. Higher nominal force levels can reduce power requirements for solenoid actuator 32 and therefore can provide increased flexibility in the design of solenoid actuator 32, such as reducing the number of windings in stator 34.

Additionally, in providing a consistent mean air gap, solenoid actuator 32 can reduce or eliminate the problem of inconsistent mean air gaps and mean force levels among similarly assembled solenoid actuators. Consistent mean force levels across air gap 38 can minimize variation in performance among similarly assembled solenoid actuators.

It will be apparent to those skilled in the art that various modifications and variations can be made in the disclosed armature assembly without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A solenoid actuator comprising:
a force transfer element defining a longitudinal axis;
an armature operatively coupled to the force transfer element;
a stator configured to selectively move the armature substantially along the axis; and
a fastening assembly to operatively connect the armature and the force transfer element, the fastening assembly being configured to allow the armature to pivot in at least one dimension relative to the axis.

2. The solenoid actuator of claim 1, wherein a retaining element is configured to maintain the armature in an adjusted armature position relative to the axis so that a top surface of the armature and a bottom surface of the stator are substantially parallel.

3. The solenoid actuator of claim 1, wherein the fastening assembly includes:
a first half-spherical portion operatively coupled to the force transfer element; and
a retaining element operatively coupled to the force transfer element, wherein
the armature is disposed between the retaining element and the first half-spherical portion, the armature being adjacent to a non-spherical side of the first half-spherical portion.

4. The solenoid actuator of claim 3, wherein the first half-spherical portion is configured to allow the armature to pivot in at least one dimension relative to the axis.

5. The solenoid actuator of claim 4, wherein
wherein the retaining element is configured to maintain the armature in an adjusted armature position relative to the axis so that a top surface of the armature and a bottom surface of the stator are substantially parallel.

6. The solenoid actuator of claim 3, the fastening assembly further including a first washer disposed about the force transfer element, a first side of the first washer being adjacent to a spherical side of the first half-spherical portion and, a second side of the first washer being adjacent to a shoulder of the force transfer element.

7. The solenoid actuator of claim 6, the retaining element including:
a nut operatively coupled to a top portion of the force transfer element and configured to apply a retaining pressure on the armature, the first half-spherical portion, the first washer, and the shoulder of the force transfer element.

8. The solenoid actuator of claim 3, the fastening assembly further including a second half-spherical portion operatively coupled to the force transfer element and disposed between the retaining element and the armature.

9. The solenoid actuator of claim 8, wherein the first and second half-spherical portions are configured to allow the armature to pivot in at least one dimension relative to the axis.

10. The solenoid actuator of claim 9,
wherein the retaining element is configured to maintain the armature in an adjusted armature position relative to the axis so that a top surface of the armature and a bottom surface of the stator are substantially parallel.

11. The solenoid actuator of claim 8, the fastening assembly further including:
a first washer disposed about the force transfer element, a first side of the first washer being adjacent to a spherical side of the first half-spherical portion, and a second side of the first washer being adjacent to a shoulder of the force transfer element; and
a second washer disposed about the force transfer element, a first side of the second washer being adjacent to a spherical side of the second half-spherical portion, and a second side of the second washer being adjacent to the retaining element.

12. The solenoid actuator of claim 11, wherein the retaining element includes a nut operatively coupled to a top portion of the force transfer element and configured to apply a retaining pressure on the second washer, the second half-spherical portion, the armature, the first washer, the first half-spherical portion, and the shoulder of the force transfer element, the fastening assembly further including:
a hollow tubular portion disposed about the force transfer element and configured to transfer the retaining pressure from the nut to the second washer to maintain the armature in an adjusted position relative to the axis.

13. The solenoid actuator of claim 1, further including:
a detaining means secured to a stationary portion of the solenoid actuator and adapted to prevent the armature from rotating about the axis.

14. A method of assembling a solenoid actuator comprising:
placing an armature on a force transfer element;
pivoting the armature relative to the force transfer element to an adjusted armature position; and
maintaining the armature in the adjusted armature position.

15. The method of claim 14 wherein maintaining the armature in the adjusted armature position includes:
securing a retaining element on the force transfer element.

16. The method of claim 14, further including:
placing a first washer on a shoulder of the force transfer element;
placing a first half-spherical portion on the force transfer element with a spherical side of the first half-spherical portion adjacent to the first washer and a non-spherical side of the first half-spherical portion adjacent to the armature.

17. The method of claim 16 further including:
placing a second washer on the force transfer element;
placing a second half-spherical portion on the force transfer element with a spherical side of the second half-spherical portion adjacent to the second washer and a non-spherical side of the second half-spherical portion adjacent to the armature.

18. The method of claim 14 wherein pivoting the armature relative to the force transfer element to an adjusted armature position further includes:
placing an alignment plunger adjacent to the armature to aid in adjusting the armature position so that a top surface of the armature and a bottom surface of the stator are substantially parallel.

19. The method of claim 18, further including:
placing an alignment guide over the alignment plunger, an outer wall of the alignment plunger being adjacent to an inner wall of the alignment guide, to aid in adjusting the armature position so that a top surface of the armature and a bottom surface of the stator are substantially parallel.

20. The method of claim 19, wherein maintaining the armature in the adjusted armature position includes securing a retaining element on the force transfer element to maintain the armature in the adjusted armature position, the method further including:
removing the alignment plunger and alignment guide; and
placing a stator over the armature.

21. A work machine comprising:
a frame;
an engine;
a fuel injector to provide fuel to the engine, a solenoid actuator in the fuel injector including:
a force transfer element defining a longitudinal axis;
an armature operatively coupled to the force transfer element;
a stator configured to selectively move the armature substantially along the axis; and
a fastening assembly to operatively connect the armature and the force transfer element, the fastening assembly being configured to allow the armature to pivot in at least one dimension relative to the axis.
